(19) United States
(12) Patent Application Publication
(10) Pub. No.: US 2019/0020614 A1
(43) Pub. Date: Jan. 17, 2019

(54) LIFE LOG UTILIZATION SYSTEM, LIFE LOG UTILIZATION METHOD, AND RECORDING MEDIUM

(71) Applicant: HONDA MOTOR CO., LTD., Tokyo (JP)

(72) Inventors: Miyuki Shimota, Wako-shi (JP); Takaichi Sano, Wako-shi (JP); Makoto Yuzawa, Wako-shi (JP); Atsushi Nishi, Wako-shi (JP); Keiichi Iguchi, Tokyo (JP); Seiichi Yamamoto, Tokyo (JP)

(21) Appl. No.: 16/029,739

(22) Filed: Jul. 9, 2018

(30) Foreign Application Priority Data
Jul. 13, 2017 (JP) 2017-136857

(51) Int. Cl. H04L 12/58; G06F 17/30; G06Q 30/02

(52) U.S. Cl. CPC H04L 51/10; G06Q 30/0226; G06F 17/30595

(57) ABSTRACT

A life log utilization system associates at least two from among event information, emotion information, and behavior information, which are acquired at the same time or within a predetermined time period, records the associated information as a life log of a user, and outputs as life content to at least the user the recorded life log or information, such as edited content, generated from the life log. In addition, the life log utilization system permits output of the life content to another user, on the condition that approval of sharing from the user has been received.

### CROSS-REFERENCE TO RELATED APPLICATION

This application is based upon and claims the benefit of priority from Japanese Patent Application No. 2017-136857 filed on Jul. 13, 2017, the contents of which are incorporated herein by reference.

### BACKGROUND OF THE INVENTION

### Field of the Invention

The present invention relates to a life log utilization system, a life log utilization method, and a recording medium, which make use of a life log collected from a target person.

### Description of the Related Art

In recent years, along with the rapid development of information processing technology, services for enriching people's lives are being provided through the analysis of so-called big data. For example, various techniques have been developed for utilizing a life log collected from a target person.

In Japanese Laid-Open Patent Publication No. 2014-191731 (see paragraph [0091], FIG. 21, etc.), an event recording device has been proposed in which the occurrence of an event acts as a trigger in order to count the number of detection times of the event caused by operation of a portable device, and the number of detection times is recorded and displayed as an event that imparts an influence on the emotions of a target person. As a specific example, a statement is made in which keystroke density information is posted to a network in the form of a blog, and the information is shared with other persons.

### SUMMARY OF THE INVENTION

Incidentally, with the apparatus proposed in Japanese Laid-Open Patent Publication No. 2014-191731 (see paragraph [0091], FIG. 21, etc.), information is simply indicated concerning an event that has an influence on the emotions, and a relationship of behaviors or emotions of the target person with respect to the occurrence of the event cannot be grasped. Thus, by generating and sharing a life log including various information acquired simultaneously and diversely through the experiences of the target person, empathy with other persons is likely to be created.

However, since it is possible to grasp the behavior of the target person by analyzing the life log of the target person, it can be said that the life log possesses an aspect as personal information. As a result, there are situations in which target persons with high consciousness concerning the protection of personal information may experience anxiety about sharing their life logs, and there is a concern that sufficient understanding cannot be obtained with respect to effectively using such a life log sharing service.

The present invention has been devised with the aim of solving the aforementioned problem, and has the object of providing a life log utilization system, a life log utilization method, and a recording medium, which are capable of increasing interest and motivation with respect to sharing of life logs.

A life log utilization system according to one aspect of the present invention includes at least two from among an event information acquisition unit configured to acquire event information in relation to an event occurring in the vicinity of a target person or in relation to an event involving the target person, an emotion information acquisition unit configured to acquire emotion information indicative of an emotional state of the target person, and a behavior information acquisition unit configured to acquire behavior information indicative of a behavior of the target person. In addition, the life log utilization system further includes a life log recording unit configured to associate at least two from among the event information acquired by the event information acquisition unit, the emotion information acquired by the emotion information acquisition unit, and the behavior information acquired by the behavior information acquisition unit, which are acquired at the same time or within a predetermined time period, and to record the associated information as a life log of the target person, a content output unit configured to output as life content to at least the target person the life log recorded by the life log recording unit or information generated from the life log, and a shared log management unit configured to perform data processing to permit output of the life content to another target person by the content output unit, on the condition that approval of sharing from the target person has been received.

In the foregoing manner, by using the life log in which at least two from among the event information, the emotion information, and the behavior information are associated, it is possible for a user to re-experience situations with rich presence through the life log of another person. On the other hand, since the output of the life content to another target person is permitted on the condition that the approval of sharing from the target person has been received, the target person discloses personal information to another person within a permissible range based on his or her own intended decision. Consequently, it is possible to increase interest and motivation with respect to sharing of life logs.

The life log utilization system may further include a life log specifying unit configured to specify, as a featured log, the life log satisfying a predetermined search condition, and the shared log management unit may carry out an inquiry process with respect to the target person, who is the source of the featured log specified by the life log specifying unit, in order to determine the approval of sharing. In accordance with this feature, it is possible to promote the sharing of life logs.

Further, the life log specifying unit may specify the life log for which a change in the emotion information is greater than or equal to a threshold value. In accordance with this feature, it is possible to detect an unconscious awareness of the target person through a change in the emotional state of the target person, and to appropriately extract a featured log that can offer attractive content, from among a large number of life logs.

In the case that a change in the emotion information of the target person before and after outputting of the life content provided from the other target person is greater than or equal to a threshold value, the shared log management unit may carry out an inquiry process in order to determine approval of sharing of the life content of the target person. Through the change in the emotional state, it is possible to further promote sharing of life logs by making a timely inquiry to the target person in whom motivation has occurred to provide his or her own life log.

The life log utilization system may further include a biometric information acquisition unit configured to acquire biometric information indicative of biological activity of the target person, and the emotion information acquisition unit may acquire the emotion information on the basis of the biometric information acquired by the biometric information acquisition unit.

The life log utilization system may further include an incentive management unit configured to give an incentive to the target person in accordance with the approval of sharing. Through such an incentive, motivation for sharing the life log can be further enhanced.

Further, the incentive management unit may give the incentive that differs depending on at least one from among a data amount, a level of rarity, a level of popularity, a level of demand, and the number of times of approval of sharing of the life log.

Further, the incentive management unit may give the incentive that differs depending on a length of time from a start time of the inquiry process until a reception time of the approval of sharing.

Further, the incentive management unit may give the incentive that is larger in the case that approval of sharing is received prior to execution of the inquiry process than in the case that approval of sharing is received after execution of the inquiry process. In accordance with this feature, since motivation to share his or her life log is made to occur promptly and voluntarily for the target person, it is possible to further promote sharing of life logs.

In addition, the life log utilization system may further include a commonality extracting unit configured to extract a commonality of information in relation to the event information or the behavior information, by analyzing the life log for which a change in the emotion information is greater than or equal to a threshold value, and a characteristic estimating unit configured to estimate a characteristic type or a characteristic pattern of the target person, on the basis of the commonality of information extracted by the commonality extracting unit, wherein the shared log management unit enables the other target person to which the life content was permitted to be outputted, to search for at least one from among the commonality of information, the characteristic type, and the characteristic pattern. In accordance with such features, it becomes easier to search for a life log of another person having similar characteristics to one's own.

A life log utilization method according to another aspect of the present invention is configured to be executed by one or a plurality of computers, and includes at least two from among an event information acquisition step of acquiring event information in relation to an event occurring in the vicinity of a target person or in relation to an event involving the target person, an emotion information acquisition step of acquiring emotion information indicative of an emotional state of the target person, and a behavior information acquisition step of acquiring behavior information indicative of a behavior of the target person. In addition, the life log utilization method further includes a recording step of associating at least two from among the event information, the emotion information, and the behavior information, which are acquired at the same time or within a predetermined time period, and recording the associated information as a life log of the target person, an outputting step of outputting as life content to at least the target person the recorded life log or information generated from the life log, and a shared management step of performing data processing to permit output of the life content to another target person by the outputting step, on the condition that approval of sharing from the target person has been received.

In a non-transitory recording medium according to yet another aspect of the present invention, there is recorded a life log utilization program configured cause one or a plurality of computers to perform at least two steps from among an event information acquisition step of acquiring event information in relation to an event occurring in the vicinity of a target person or in relation to an event involving the target person, an emotion information acquisition step of acquiring emotion information indicative of an emotional state of the target person, and a behavior information acquisition step of acquiring behavior information indicative of a behavior of the target person, and to further perform a recording step of associating at least two from among the event information, the emotion information, and the behavior information, which are acquired at the same time or within a predetermined time period, and recording the associated information as a life log of the target person, an outputting step of outputting as life content to at least the target person the recorded life log or information generated from the life log, and a shared management step of performing data processing to permit output of the life content to another target person by the outputting step, on the condition that approval of sharing from the target person has been received.

In accordance with the life log utilization system, the life log utilization method, and the recording medium of the present invention, it is possible to increase interest and motivation with respect to sharing of life logs.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall configuration diagram of a life log utilization system according to an embodiment of the present invention;

FIG. 2 is a functional block diagram of a log management server shown in FIG. 1;

FIG. 3 is a first flowchart for describing operations of the life log utilization system shown in FIG. 1;

FIG. 4 is a second flowchart for describing operations of the life log utilization system shown in FIG. 1;

FIG. 5 is a third flowchart for describing operations of the life log utilization system shown in FIG. 1;

FIG. 6 is a diagram exemplifying estimation results of user characteristics;

FIG. 7 is an image diagram illustrating an inquiry screen for approval or disapproval of sharing;

FIG. 8 is a diagram schematically showing a method of determining the amount of an incentive to be given;

FIG. 9A is a diagram illustrating an example of a data structure of the life log;

FIG. 9B is a diagram illustrating an example of a data structure of classification data;

FIG. 9C is a diagram illustrating an example of a data structure of personal data;

FIG. 10 is a fourth flowchart for describing operations of the life log utilization system shown in FIG. 1; and

FIG. 11 is a diagram showing an example of an output form of edited content.

### DESCRIPTION OF THE PREFERRED EMBODIMENTS

A preferred embodiment of a life log utilization system according to the present invention, in relation to a life log utilization method and a life log utilization program, will be presented and described in detail below with reference to the accompanying drawings.

### [Configuration of Life Log Utilization System 10]

### <Overall Configuration>

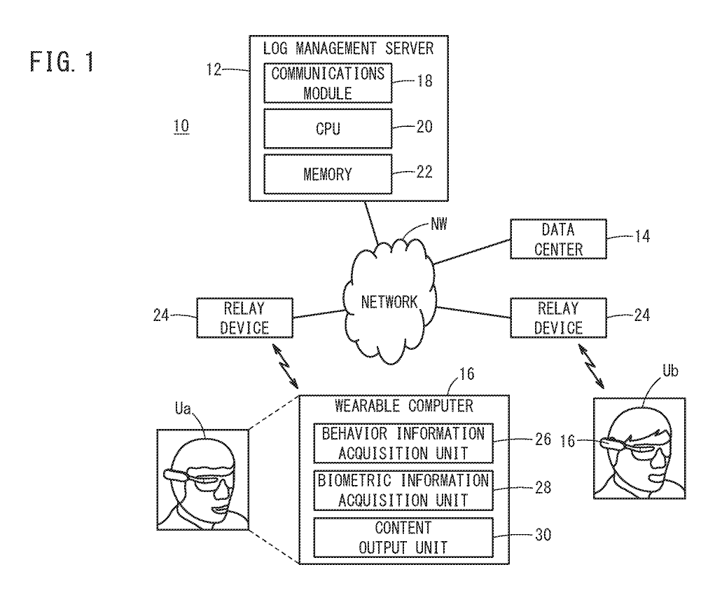

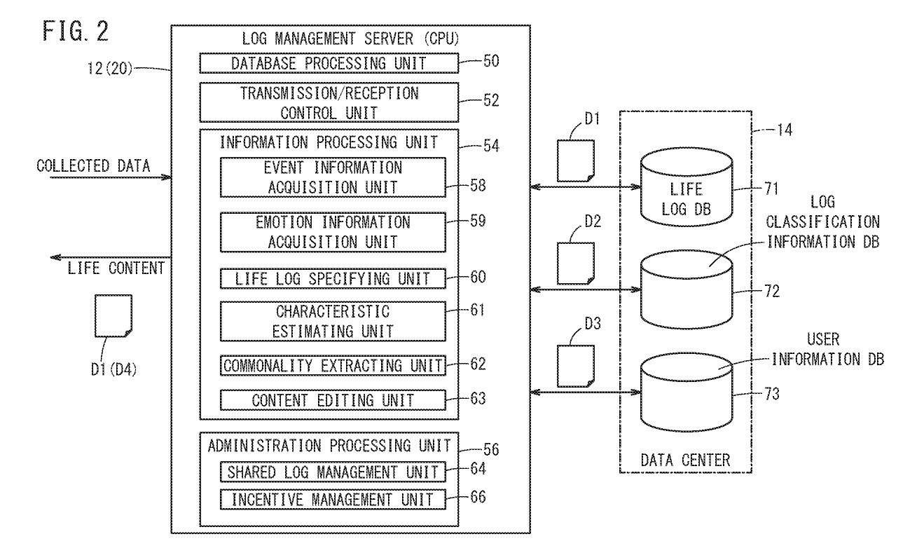

FIG. 1 is an overall configuration diagram of a life log utilization system 10 according to an embodiment of the present invention. The life log utilization system 10 is a system configured to collect life logs D1 (see FIG. 2) for each of users Ua, Ub who have been registered as users of the service, and to be capable of mutually sharing the life logs D1 as attractive content. More specifically, the life log utilization system 10 is configured to include a log management server 12, a data center 14, and a wearable computer 16.

The log management server 12 is a computer that plays a central role in the life log utilization system 10. The log management server 12 is configured to include a communications module 18, a CPU 20 (Central Processing Unit), and a memory 22. Moreover, the memory 22 is a non-transitory storage medium (non-transitory recording medium), and is constituted by a computer-readable storage medium.

A plurality of different types of databases (to be described later) are constructed by a server (not shown) installed in the data center 14. The data center 14 is configured to be capable of communicating mutually with the log management server 12 via a network NW (for example, the Internet). Consequently, data can be exchanged between the data center 14 and the log management server 12.

The wearable computer 16 is a multifunction/multipurpose device which can be used in a state of being worn by the users Ua, Ub, and is configured to include, for example, a housing, a control circuit board, a display panel, a speaker, or a plurality of sensors. Consequently, the wearable computer 16 functions as a behavior information acquisition unit 26, a biometric information acquisition unit 28, and a content output unit 30.

The sensors that are mounted in the wearable computer 16 may include, for example, any of a camera, a vitality sensor, a motion sensor, a position sensor, or an audio sensor. More specifically, by analyzing sensor values from these sensors, it is possible to detect a heartbeat, a pulse, a blood pressure, the pupils, a line of sight, movements, a position, or voices of the users Ua, Ub.

In the example shown in the drawings, the wearable computer 16 is made up of so-called VR (Virtual Reality) goggles, however, the wearable computer 16 may be a head mounted display having another form. Further, the wearable computer 16 may be configured to be capable of communicating with an attached output device (for example, a display, a projector), and instead of displaying images by itself, may display images on the output device.

### <Functional Block Diagram of Log Management Server 12>

FIG. 2 is a functional block diagram of the log management server 12 shown in FIG. 1. The CPU 20 of the log management server 12, by reading out and executing programs stored in the memory 22, functions as a database processing unit 50, a transmission/reception control unit 52, an information processing unit 54, and an administration processing unit 56.

The information processing unit 54 is constituted to include an event information acquisition unit 58, an emotion information acquisition unit 59, a life log specifying unit 60, a characteristic estimating unit 61, a commonality extracting unit 62, and a content editing unit 63. The administration processing unit 56 is configured to include a shared log management unit 64 and an incentive management unit 66.

In the data center 14, for example, there are constructed three types of databases, and more specifically, a database relating to the life logs D1 (hereinafter referred to as a life log DB 71), a database relating to classification data D2 of the life logs D1 (hereinafter referred to as a log classification information DB 72), and a database relating to personal data D3 (hereinafter referred to as a user information DB 73).

### [Operations of the Life Log Utilization System 10]

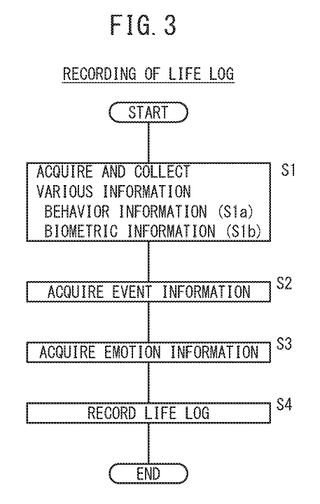

In the present embodiment, the life log utilization system 10 is configured in the manner described above. Next, a description will be presented with reference to FIGS. 3 to 11 concerning operations of the life log utilization system 10.

### <First Operation: Recording of Life Log D1>

In step S1 of FIG. 3, the life log utilization system 10 acquires various types of information used for generating the life log D1. More specifically, in step S1a, the behavior information acquisition unit 26 acquires information (hereinafter referred to as behavior information) indicative of behaviors of the user Ua. In step S1b, the biometric information acquisition unit 28 acquires information (hereinafter referred to as biometric information) indicative of biological activity of the user Ua.

Steps S1a and S1b may be executed synchronously, or may be executed asynchronously (for example, at each of different cycles). With an accumulation of a predetermined amount of data acting as a trigger, the wearable computer 16 transmits data (hereinafter referred to as collected data) including the behavior information and the biometric information which are collected from the user Ua, to the log management server 12.

After having received and acquired the data collected from each of the users (in this instance, the user Ua) via the relay devices 24, the network NW, and the communications module 18, the log management server 12 temporarily stores the collected data in the memory 22.

In step S2, the event information acquisition unit 58 acquires event information associated with the information (particularly, the behavior information) that was acquired in step S1. More specifically, the event information acquisition unit 58 acquires the event information by extracting a portion of the behavior information, or by analyzing the content of the behavior information, and estimating an event.

In this instance, the “event information” is defined as information related to an event that occurs in the vicinity of the user Ua or an event involving the user Ua. Such an event may be a behavior unit that is classified to an extent for which behavior analysis thereof is possible, may be an abstract event (for example, traveling or trip, a date, or a festival), or may be a particular and concrete event (for example, a meeting, a conversation, a behavior taking place during commuting).

In step S3, the emotion information acquisition unit 59 acquires emotion information associated with the information (i.e., the collected data) that was acquired in step S1. More specifically, the emotion information acquisition unit 59 estimates the emotional state of the user Ua on the basis of the biometric information included in the collected data, and acquires an estimation result (quantitative value) as emotion information.

Prior to this estimation, for example, the emotion information acquisition unit 59 may detect a level of emotional excitement by grasping a change in the heart rate, or may detect a facial expression by carrying out image processing with respect to a camera image including the face. In addition, on the basis of one or a plurality of the aforementioned detection results, the emotion information acquisition unit 59 quantifies the emotional state of the user Ua using one or a plurality of parameters (for example, happiness, anger, sorrow, pleasure).

In this instance, although the emotion information acquisition unit 59 generates the emotion information on the basis of the biometric information of the user Ua, the method of acquiring the emotion information is not limited to this feature. For example, the emotion information acquisition unit 59 may newly acquire data (in this instance, the emotion information of the user Ua), which is associated with the aforementioned collected data in accordance with a collection time period (for example, in units of any of a given date, hours, minutes, or seconds), from an external server that differs from the log management server 12.

In step S4, the data center 14 (and more specifically, the life log DB 71) associates the information acquired in steps S1 through S3, and records the associated information as a life log D1 of the user Ua. Prior to recording such information, the database processing unit 50 performs a process (i.e., a data coupling process) of associating information that was acquired at the same time or within a predetermined time period.

First, in the event that the acquisition time of the behavior information coincides with the acquisition time of biometric information within a permissible range (for example, within one minute), the database processing unit 50 regards the behavior information and the biometric information as having relevance, and associates the behavior information with the biometric information. Thereafter, in the case that a predetermined condition for linking or associating the event information is satisfied, the database processing unit 50 further associates the event information with respect to the previously associated information set (the behavior information and the biometric information).

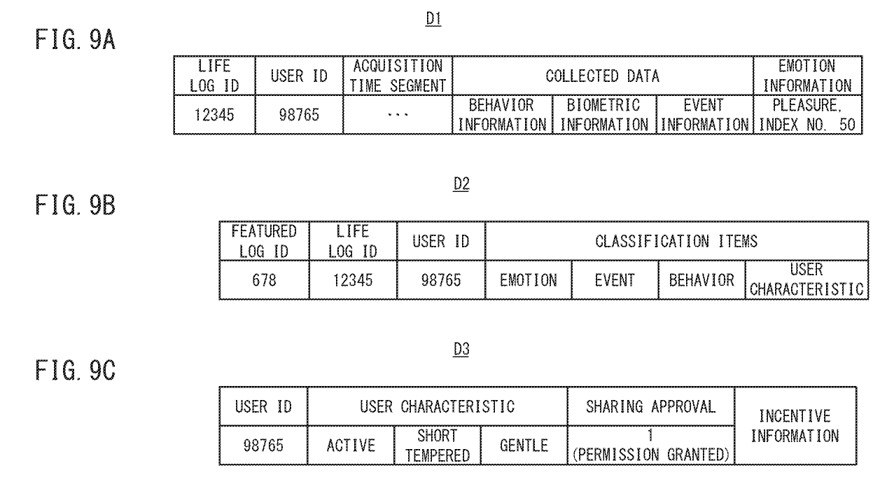

FIG. 9A is a diagram illustrating an example of a data structure of the life log D1. The present diagram corresponds to a record that makes up a constituent unit of the life log DB 71. The life log D1 is configured to include a life log ID, a user ID, an acquisition time segment, collected data (including behavior information, biometric information, and event information), and emotion information. In this instance, the life log ID (=12345) is an identifier unique to the life log D1. Further, the user ID (=98765) is an identifier unique to the user Ua.

As long as it is possible to generate the record of the life log D1 shown in FIG. 9A, for example, an arbitrary type of database including a hierarchical type, a network type, or a relational type of database may be adopted. Such a feature also applies to the classification data D2 (FIG. 9B) and the personal data D3 (FIG. 9C) which will be described later.

Thereafter, the transmission/reception control unit 52 transmits the data to be recorded including the life log D1 to the data center 14. Consequently, the life log DB 71 records the life log D1 of the user Ua which is formed by associating at least the behavior information, the biometric information, the event information, and the emotion information.

In this manner, the life log utilization system 10 completes the first operation (recording the life log D1). By repeatedly executing the process of the flowchart of FIG. 3 in a periodic or irregular manner, the life log utilization system 10 is capable of sequentially collecting life logs D1 of the user Ua who has registered to use the service. Similarly, by performing the above-described first operation, the life log utilization system 10 sequentially collects the life log D1 of a user Ub, who is different from the user Ua.

### <Second Operation: Generation of Classification Data D2>

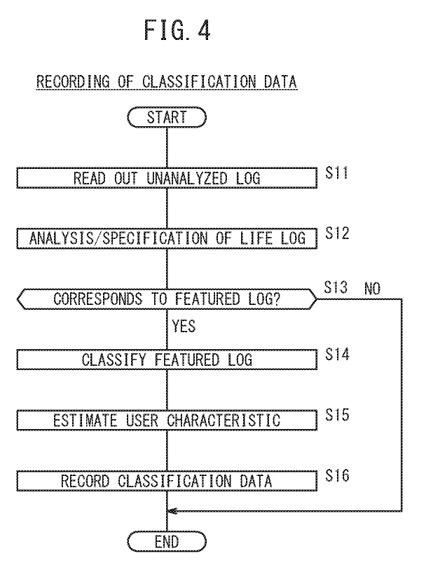

In step S11 of FIG. 4, the database processing unit 50 refers to the life log DB 71 of the data center 14, and reads out a life log D1 (an arbitrary number of records) which has not yet been analyzed. Such an analysis state is determined, for example, by referring to tag information of the life log D1 (for example, a flag indicative of the analysis state).

In step S12, the life log specifying unit 60 analyzes the content of the life log D1 read in step S11, and specifies whether or not it is a life log D1 (hereinafter referred to as a featured log) indicative of content that is worthy of being shared. For example, the life log specifying unit 60 may specify, as a featured log, a life log D1 for which a change in the emotion information is greater than or equal to a threshold value, or a life log D1 for which a degree of statistical deviation of the behavior information is greater than or equal to a threshold value.

In step S13, the life log specifying unit 60 determines whether the life log D1 that was analyzed in step S12 corresponds to a featured log. More specifically, in the case it is determined that a featured log does not exist among the targets for analysis (step S13: NO), the process of the flowchart of FIG. 4 is immediately brought to an end. On the other hand, in the case it is determined that a featured log does exist among the targets for analysis (step S13: YES), the process proceeds to the following step S14.

In step S14, the commonality extracting unit 62 analyzes the featured log that was specified in step S13 (in this instance, the life log D1 for which a change in the emotion information is greater than or equal to the threshold value), and thereby extracts a commonality (hereinafter referred to as a commonality of information) in relation to the event information or the behavior information. In addition, the commonality extracting unit 62 classifies the featured log in accordance with a predetermined rule, and assigns the classification items thereof in relation to an “emotion”, an “event”, or a “behavior” to the featured log.

In step S15, the characteristic estimating unit 61 estimates a characteristic (hereinafter referred to as a user characteristic) of the user Ua on the basis of the classification result in step S14. More specifically, the characteristic estimating unit 61 estimates one or a plurality of user characteristics (types or patterns) in accordance with a combination of the classification items (an emotion, an event, an action) that were assigned in step S14. For example, in the case that a plurality of featured logs exist, the most appropriate user characteristic can be determined using a statistical method including adoption of a mode value (majority decision) and average processing.

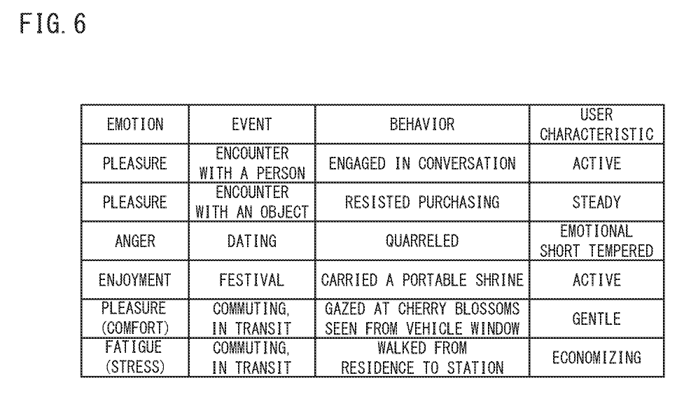

FIG. 6 is a diagram exemplifying estimation results of user characteristics. The present drawing corresponds to table data indicating a relationship of the user characteristic with respect to combinations of three types of classification items (emotion, event, and behavior). For example, in the case that the user's emotion is “pleasure”, the event is “encounter with a person”, and the behavior is “talking to the person (engaged in conversation)”, a user characteristic of “active” is obtained. In the content of the user characteristics, in addition to active, there may be included, for example, steadiness, being emotional, short temper, gentle, and economical.

In this manner, the characteristic estimating unit 61 may estimate the characteristic of the user Ua by extracting a commonality among the event information or the behavior information included in one or a plurality of featured logs. In accordance with this feature, it is possible to express characteristics of the user that were performed unconsciously.

In step S16 of FIG. 4, the data center 14 (and more specifically, the log classification information DB 72) records the classification data D2 including the classification items assigned in step S14 and the user characteristics estimated in step S15.

FIG. 9B is a diagram illustrating an example of a data structure of the classification data D2. The present diagram corresponds to a record that makes up a constituent unit of the log classification information DB 72. The classification data D2 includes a featured log ID, a life log ID, a user ID, and the classification items (an emotion, an event, a behavior, and a user characteristic). In this instance, the featured log ID (=678) is an identifier that is unique to the classification data D2, which is managed in a unitary manner in the log classification information DB 72.

Thereafter, the transmission/reception control unit 52 transmits the data to be recorded including the classification data D2 to the data center 14. Consequently, the log classification information DB 72 records the classification data D2 in relation to the specified life log D1 (featured log).

In the foregoing manner, the life log utilization system 10 completes the second operation (generation of the classification data D2). The life log utilization system 10 is capable of specifying and classifying attractive content from among a large number of life logs D1, by repeatedly executing the process of the flowchart of FIG. 4, for example, within a time zone in which the operation rate of the log management server 12 is low.

### <Third Operation: Sharing of Life Log D1>

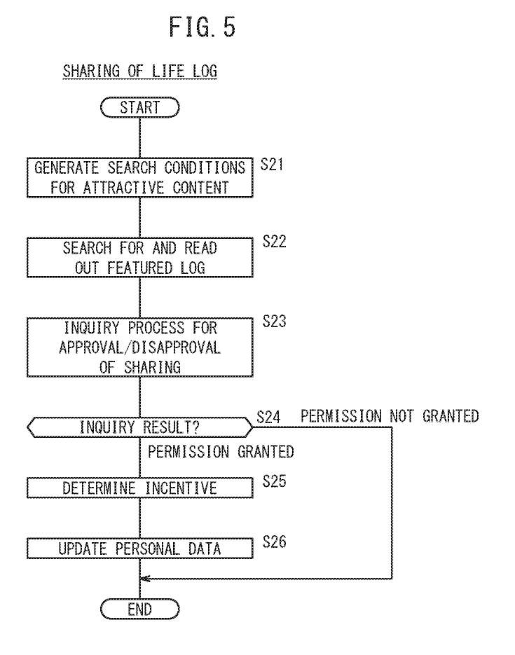

In step S21 of FIG. 5, the shared log management unit 64 generates search conditions for attractive content. In this instance, “attractive content” refers to content having high commercial value, for which it can be thought that a considerable number of users may wish to re-experience the content. As search conditions, there may be cited, for example, a subject (a person, a thing, or information) that creates a strong impression, or possesses a high degree of rarity, a high degree of fame, a high level of fashion or popularity, or a high level of demand.

In step S22, the shared log management unit 64 reads out and acquires a featured log (life log D1) and classification data D2 matching the search conditions generated in step S21.

In step S23, the shared log management unit 64 carries out an inquiry process with respect to the source (user Ua) of the featured log that was read out in step S22, in order to obtain approval of sharing of the featured log. More specifically, the transmission/reception control unit 52 transmits the inquiry request signal, which is generated by the shared log management unit 64, to the wearable computer 16 of the user Ua. Consequently, the wearable computer 16 visually displays an inquiry screen for approval or disapproval of sharing of the featured log, utilizing the display function that is incorporated therein.

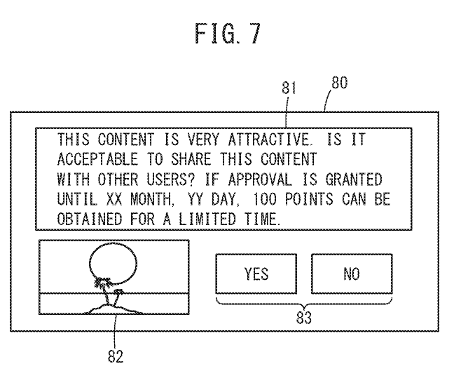

As shown in FIG. 7, in a display area 80 of the wearable computer 16, there are arranged a message field 81 providing a description of the inquiry, a thumbnail 82 indicating the content, and two buttons 83 denoted by [YES] and [NO]. An operation of the user Ua to select one of the buttons 83 (YES/NO) acts as a trigger, whereupon the process proceeds to the following step S24.

In step S24 of FIG. 5, the shared log management unit 64 confirms the response result of the user Ua with respect to the inquiry process that was performed in step S23. In the case that “YES” is selected (step S24: permission granted), the process proceeds to the following step S25. On the other hand, in the case that “NO” is selected (step S24: permission not granted), the process skips over steps S25 and S26, and the process of the flowchart of FIG. 5 is immediately brought to an end.

In step S25, the incentive management unit 66 determines an amount of incentive (consideration) to be given accompanying the approval of sharing of the life log D1. Such an incentive, for example, may be an advantageous condition when receiving the service, information indicating a grade or ranking for participants of the service, or points exchangeable for goods or money.

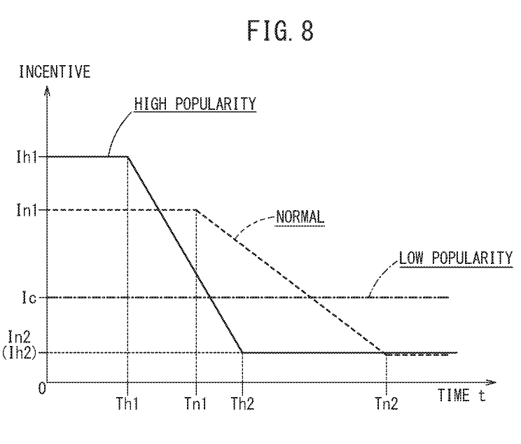

FIG. 8 is a diagram schematically showing a method of determining the amount of an incentive to be given. Time (units: days) is shown on the horizontal axis, and a granted amount of incentive (in arbitrary units) is shown on the vertical axis of the graph. In this instance, the time t=0 corresponds to the starting time of the sharing approval/disapproval inquiry process (step S23).

As can be understood from the present drawing, different curves are set in accordance with the type of life log D1. For example, in the case of a “normal” life log, the incentive is a constant value (In1) within a range of 0≤t<Tn1, decreases linearly within a range of Tn1≤t<Tn2, and is a constant value (In2) within a range of t≤Tn2.

In contrast thereto, in the case of a “high popularity” life log, the incentive is a constant value (Ih1) within a range of 0≤t<Th1, decreases linearly within a range of Th1≤t<Th2, and is a constant value (Ih2) within a range of t≥Th2. Stated otherwise, the amount of incentive is determined so as to be correlated roughly with the degree of public attention, and satisfies the relationships of Ih1>In1 and Th1<Tn1.

Incidentally, in the case of a “low popularity” life log, the incentive is a constant value (Ic) regardless of the time (t). This is because, although there are few user populations that have interest in such a life log D1, a certain level of need therefor can always be expected.

In this manner, the incentive management unit 66 provides an incentive to the user Ua depending on the approval of sharing of the life log D1 (for example, each time the approval for sharing is granted). Through such an incentive, motivation for sharing the life log D1 can be further enhanced.

Further, the incentive management unit 66 may give different incentives depending on at least one from among a data amount, a level of rarity, a level of popularity, a level of demand, and the number of times of approval of sharing of the life log D1. In addition to or instead of this feature, the incentive management unit 66 may give different incentives depending on a length of time from the start time of the inquiry process until a reception time of the approval of sharing.

Further, the incentive management unit 66 may give a larger incentive in the case that approval of sharing is received prior to execution of the inquiry process (step S23 of FIG. 5) than in the case that approval of sharing is received after execution of the inquiry process. In accordance with this feature, since motivation to share his or her life log D1 is made to occur promptly and voluntarily for the user Ua, it is possible to further promote sharing of life logs D1.

In step S26 of FIG. 5, the data center 14 (and more specifically, the user information DB 73) overwrites and updates the personal data D3 concerning the user Ua, on the basis of the calculation results in accordance with steps S24 and S25.

FIG. 9C is a diagram illustrating an example of a data structure of the personal data D3. The present diagram corresponds to a record that makes up a constituent unit of the user information DB 73. The personal data D3 is configured to include a user ID, a user characteristic (in this instance, of three types including active, short tempered, and gentle), approval of sharing (a flag value), and incentive information.

In this instance, the sharing approval flag corresponds to a sharing approval/disapproval state value of the life log D1, indicating “approval of sharing” when the flag value is 1, and “disapproval of sharing” when the flag value is 0. For example, although in its initial state the flag value is 0, in the case that “approval of sharing” is received for the first time, the flag value is updated from 0 to 1.

Further, the incentive information is information indicating the granted state of the incentive, and as examples thereof, there can be cited a total of granted amounts, or a grant history (grant time, grant amount, reason for granting). Stated otherwise, the incentive information is updated taking into consideration the most recently determined grant amount.

Thereafter, the transmission/reception control unit 52 transmits the data to be recorded including the personal data D3 to the data center 14. Consequently, the user information DB 73 records the personal data D3 in relation to the specified life log D1 (featured log).

In this manner, the life log utilization system 10 completes the third operation (sharing of the life log D1). By repeatedly executing the process of the flowchart of FIG. 5, for example, within a time zone in which the operation rate of the log management server 12 is low, the life log utilization system 10 makes inquiries with respect to the source of the attractive content, and the life log D1 can be shared.

### <Fourth Operation: Output of Edited Content D4>

Incidentally, it is considered that the user Ub may desire to re-experience a situation with rich presence through the life log D1 of another person. In this case, the life log utilization system 10 is capable of providing the edited content D4 to the user Ub.

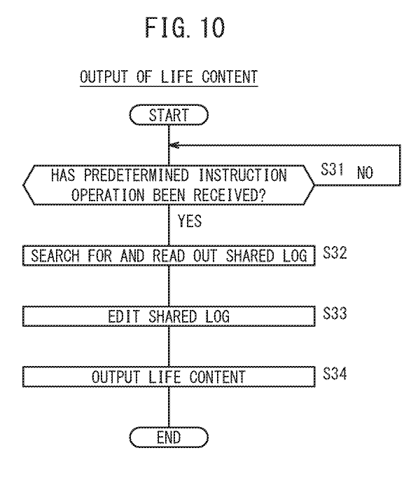

In step S31 of FIG. 10, the log management server 12 determines whether or not a predetermined instruction operation (i.e., a request from the user Ub) has been received from the wearable computer 16 of the user Ub. An interface (HMI: Human Machine Interface) for accepting such an instruction operation may adopt various forms, including a mode of selecting from a displayed content list.

If an instruction operation has not yet been received (step S31: NO), the process remains at step S31 until such an operation is received. On the other hand, in the case that an instruction operation is received (step S31: YES), the process proceeds to the following step S32.

In step S32, the database processing unit 50 performs a searching process of the life log DB 71 in accordance with the instruction (selection of content) made in step S31, and reads out a life log D1 (hereinafter also referred to as a shared log) that matches the search condition. As search conditions, there may be cited, for example, coincidence of the classification items, and the value of the sharing approval flag.

For example, the shared log management unit 64 mutually refers to the personal data D3 of the users Ua and Ub, and determines whether or not a combination of the user characteristics coincide with or are similar to each other, and also determines whether or not approval of sharing is authorized between the users Ua and Ub.

In this instance, the shared log management unit 64 may be configured to enable the user Ub to whom the life content was permitted to be outputted, to search for at least one from among the commonality of information extracted by the commonality extracting unit 62, and the characteristic type and the characteristic pattern estimated by the characteristic estimating unit 61. Consequently, it becomes easier to search for a life log D1 of a user Ua having similar characteristics to one's own.

In step S33, as necessary, the content editing unit 63 performs an editing process on the shared log that was read out in step S32. As such an editing process, there may be cited, for example, [1] an annotation process for annotating moving images or still images, [2] a graph creation process for expressing time series data in the form of a graph, and [3] a thinning-out process/trimming process for shortening the time required to reproduce the moving images.

Hereinafter, the life log D1 and the edited content D4 that is generated from the life log D1 will be collectively referred to as “life content” in certain cases. Moreover, newly generated edited content D4 may be recorded in the data center 14 (for example, the life log DB 71).

In step S34, the content output unit 30 outputs to the user Ub the life content that was acquired in step S32 or step S33. Prior to the output thereof, the transmission/reception control unit 52 transmits the life content to the wearable computer 16 of the user Ub. The wearable computer 16 visually displays the life content (in this instance, the edited content D4) utilizing the display function that is incorporated therein.

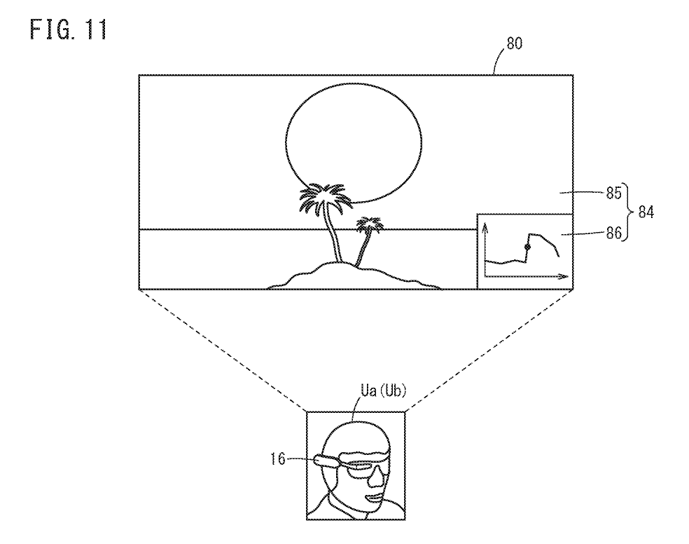

As shown in FIG. 11, within the display area 80 of the wearable computer 16, a virtual world 84 for displaying behaviors and actions from the eyes of the user Ua is generated. Such a virtual world 84 is composed of a reproduced moving image 85 showing a situation in which the user Ua is taking an excursion around a tropical island, and a graph 86 superimposed on a lower right corner of the reproduced moving image 85. The graph 86 shows changes over time of the emotional state (for example, a quantitative value of happiness) of the user Ua.

In this manner, the content output unit 30 may be configured to generate the virtual world 84 in which a behavior of the user Ua is virtually reproduced using at least the shared log. Consequently, the user Ub can re-experience the situation with rich presence through the virtual world 84. Moreover, the user Ua can experience the virtual world 84 according to his or her own life log D1, regardless of whether or not approval of sharing was authorized.

Incidentally, in the case that the change in the emotion information of the user Ua before and after outputting of the life content (the life log D1 or the edited content D4) provided from the user Ub is greater than or equal to a threshold value, the shared log management unit 64 may carry out an inquiry process in order to determine approval of sharing of the life content of the user Ua. Thus, through the change in the emotional state, it is possible to further promote sharing of the life log D1 by making a timely inquiry to the user Ua in whom motivation has occurred to provide his or her own life log D1.

### [Effects of the Life Log Utilization System 10]

As discussed above, the life log utilization system 10 includes at least two from among [1] the event information acquisition unit 58 that acquires event information in relation to an event occurring in the vicinity of the user Ua (target person) or in relation to an event involving the user Ua, the emotion information acquisition unit 59 that acquires emotion information indicative of the emotional state of the user Ua, and the behavior information acquisition unit 26 that acquires behavior information indicative of a behavior of the user Ua. In addition, the life log utilization system further includes [2] the life log DB 71 (life log recording unit) that associates at least two from among the event information, the emotion information, and the behavior information, which are acquired at the same time or within a predetermined time period, and to record the associated information as a life log D1 of the user Ua, [3] the content output unit 30 that outputs as life content to at least the user Ua the recorded life log D1 or information (edited content D4) generated from the life log D1, and [4] the shared log management unit 64 configured to perform data processing to permit output of the life content to the user Ub (another target person) by the content output unit 30, on the condition that approval of sharing from the user Ua has been received.

Further, according to the life log utilization method and program, one or a plurality of computers performs at least two from among [1] an event information acquisition step (S2) of acquiring the event information, an emotion information acquisition step (S3) of acquiring the emotion information, and the behavior information acquisition step (S1) of acquiring the behavior information, and also performs [2] the recording step (S4) of recording the life log D1, [3] the outputting step (S34) of outputting to at least the user Ua the life log D1 or information (edited content D4) generated from the life log D1, and [4] the shared management step (S26) of preforming data processing to permit outputting of the life content to another user Ub, on the condition that approval of sharing from the user Ua has been received.

In the foregoing manner, by using the life log D1 in which at least two from among the event information, the emotion information, and the behavior information are associated, it is possible for a user Ub to re-experience situations with rich presence through the life log D1 of another person (user Ua). On the other hand, since the output of the life content to the user Ub is permitted on the condition that the approval of sharing from the user Ua has been received, the user Ua can disclose personal information to the user Ub within a permissible range based on his or her own intended decision. Consequently, it is possible to increase interest and motivation with respect to sharing of the life log D1.

Further, the life log utilization system 10 may further include [5] the life log specifying unit 60 which specifies, as a featured log, a life log D1 satisfying a predetermined search condition, and [6] the shared log management unit 64 may carry out an inquiry process with respect to the user Ua, who is the source of the featured log that was specified, in order to determine the approval of sharing. In accordance with this feature, it is possible to promote sharing of the life log D1.

Further, [7] the life log specifying unit 60 may specify a life log D1 for which a change in the emotion information is greater than or equal to a threshold value. In accordance with this feature, it is possible to detect an unconscious awareness of the user Ua through a change in the emotional state of the user Ua, and to appropriately extract a featured log that can offer attractive content, from among a large number of life logs D1.

Further, the life log utilization system 10 may further include [8] the biometric information acquisition unit 28 that acquires biometric information indicative of biological activity of the user Ua, and [9] the emotion information acquisition unit 59 may acquire the emotion information on the basis of the acquired biometric information.

### [Supplemental Considerations]

The present invention is not limited to the above-described embodiment, and goes without saying that the present invention may be freely modified within a range that does not depart from the scope of the invention. Alternatively, the respective configurations may be arbitrarily combined within a range in which technical

What is claimed is:

1. A life log utilization system comprising at least two from among;
an event information acquisition unit configured to acquire event information in relation to an event occurring in a vicinity of a target person or in relation to an event involving the target person;
an emotion information acquisition unit configured to acquire emotion information indicative of an emotional state of the target person; and
a behavior information acquisition unit configured to acquire behavior information indicative of a behavior of the target person; and
the life log utilization system further comprising;
a life log recording unit configured to associate at least two from among the event information acquired by the event information acquisition unit, the emotion information acquired by the emotion information acquisition unit, and the behavior information acquired by the behavior information acquisition unit, which are acquired at a same time or within a predetermined time period, and to record the associated information as a life log of the target person;
a content output unit configured to output as life content to at least the target person the life log recorded by the life log recording unit or information generated from the life log; and
a shared log management unit configured to perform data processing to permit output of the life content to another target person by the content output unit, on a condition that approval of sharing from the target person has been received.

2. The life log utilization system according to claim 1, further comprising:
a life log specifying unit configured to specify, as a featured log, the life log satisfying a predetermined search condition;
wherein the shared log management unit carries out an inquiry process with respect to the target person, who is a source of the featured log specified by the life log specifying unit, in order to determine the approval of sharing.

3. The life log utilization system according to claim 2, wherein the life log specifying unit specifies the life log for which a change in the emotion information is greater than or equal to a threshold value.

4. The life log utilization system according to claim 1, wherein, in a case that a change in the emotion information of the target person before and after outputting of the life content provided from the other target person is greater than or equal to a threshold value, the shared log management unit carries out an inquiry process in order to determine approval of sharing of the life content of the target person.

5. The life log utilization system according to claim 1, further comprising:
a biometric information acquisition unit configured to acquire biometric information indicative of biological activity of the target person;
wherein the emotion information acquisition unit acquires the emotion information, based on the biometric information acquired by the biometric information acquisition unit.

6. The life log utilization system according to claim 1, further comprising an incentive management unit configured to give an incentive to the target person in accordance with the approval of sharing.

7. The life log utilization system according to claim 6, wherein the incentive management unit gives the incentive that differs depending on at least one from among a data amount, a level of rarity, a level of popularity, a level of demand, and a number of times of approval of sharing, of the life log.

8. The life log utilization system according to claim 2, further comprising an incentive management unit configured to give an incentive to the target person in accordance with the approval of sharing;
wherein the incentive management unit gives the incentive that differs depending on a length of time from a start time of the inquiry process until a reception time of the approval of sharing.

9. The life log utilization system according to claim 4, further comprising an incentive management unit configured to give an incentive to the target person in accordance with the approval of sharing;
wherein the incentive management unit gives the incentive that differs depending on a length of time from a start time of the inquiry process until a reception time of the approval of sharing.

10. The life log utilization system according to claim 2, further comprising an incentive management unit configured to give an incentive to the target person in accordance with the approval of sharing;
wherein the incentive management unit gives the incentive that is larger in a case that approval of sharing is received prior to execution of the inquiry process than in a case that approval of sharing is received after execution of the inquiry process.

11. The life log utilization system according to claim 4, further comprising an incentive management unit configured to give an incentive to the target person in accordance with the approval of sharing;
wherein the incentive management unit gives the incentive that is larger in a case that approval of sharing is received prior to execution of the inquiry process than in a case that approval of sharing is received after execution of the inquiry process.

12. The life log utilization system according to claim 1, further comprising:
a commonality extracting unit configured to extract a commonality of information in relation to the event information or the behavior information, by analyzing the life log for which a change in the emotion information is greater than or equal to a threshold value; and
a characteristic estimating unit configured to estimate a characteristic type or a characteristic pattern of the target person, based on the commonality of information extracted by the commonality extracting unit;
wherein the shared log management unit enables the other target person to which the life content was permitted to be outputted, to search for at least one from among the commonality of information, the characteristic type, and the characteristic pattern.

13. A life log utilization method configured to be executed by one or a plurality of computers, the life log utilization method comprising at least two from among:
an event information acquisition step of acquiring event information in relation to an event occurring in a vicinity of a target person or in relation to an event involving the target person;
an emotion information acquisition step of acquiring emotion information indicative of an emotional state of the target person; and
a behavior information acquisition step of acquiring behavior information indicative of a behavior of the target person; and
the method further comprising;
a recording step of associating at least two from among the event information, the emotion information, and the behavior information, which are acquired at a same time or within a predetermined time period, and recording the associated information as a life log of the target person;
an outputting step of outputting as life content to at least the target person the recorded life log or information generated from the life log; and
a shared management step of performing data processing to permit output of the life content to another target person by the outputting step, on a condition that approval of sharing from the target person has been received.

14. A non-transitory recording medium in which there is recorded a life log utilization program configured to cause one or a plurality of computers to perform at least two steps of:
an event information acquisition step of acquiring event information in relation to an event occurring in a vicinity of a target person or in relation to an event involving the target person;
an emotion information acquisition step of acquiring emotion information indicative of an emotional state of the target person; and
a behavior information acquisition step of acquiring behavior information indicative of a behavior of the target person; and to further perform:
a recording step of associating at least two from among the event information, the emotion information, and the behavior information, which are acquired at a same time or within a predetermined time period, and recording the associated information as a life log of the target person;
an outputting step of outputting as life content to at least the target person the recorded life log or information generated from the life log; and
a shared management step of performing data processing to permit output of the life content to another target person by the outputting step, on a condition that approval of sharing from the target person has been received.
